(19) United States
(12) Patent Application Publication
(10) Pub. No.: US 2002/0073551 A1
(43) Pub. Date: Jun. 20, 2002

(54) Chain saw - oil cap

(76) Inventor: Steven Goodwin, Spennymoor (GB)

Correspondence Address: BLACK & DECKER CORPORATION, 701 E. JOPPA ROAD - TW199, TOWSON, MD, 21286, US

(21) Appl. No.: 09/991,853

(22) Filed: Nov. 16, 2001

(30) Foreign Application Priority Data
Nov. 17, 2000 (GB) GB0028087.5

(51) Int. Cl. B27B 17/02; B26B 9/00

(52) U.S. Cl. 30/123.4; 30/383; 30/350

(57) ABSTRACT

A chain saw comprising an oil container for storage of lubricating oil, the container having an oval neck through which the container can be filled with a lubricating oil and a cap for sealing the neck of the container wherein the cap comprises a body having at least one elastically spreadable band located around the body along at least part of the length of the body and an actuating mechanism which is capable of moving the band from a relaxed inner position to a spread outer position into engagement of the inner surface of the neck of the container when the body of the cap is located within the neck of the container. The longitudinal axis of the neck can be non linear.

The present invention relates to chain saws and in particular to the apparatus and methods of sealing an oil reservoir on a chain saw.

A chain saw comprises a body from which extends a chain bar. A cutting chain is driven around the chain bar by a motor mounted within the body. The motor can either be an internal combustion engine or an electric motor. The chain saw is supported by an operator in use by two handles, a first rear handle located at the rear of the body and the second bale handle located on the side of the body. The chain saw is operated by a trigger switch mounted on the rear handle.

As the chain rotates around the chain bar, it is required to be lubricated to minimise the friction between the chain and the chain bar. Therefore, in standard designs of chain saw, a lubricating oil is continuously dripped onto the chain of the chain saw as it rotates around the chain bar. The lubricating oil is stored within a container which acts as a reservoir mounted within the body of the chain saw and is fed by a pipe from the container to the chain where it is continually fed onto the chain. A valve is utilised to control the rate of flow of the oil onto the chain saw.

The oil container comprises a neck through which oil can be poured in order to fill the container with oil. The neck of the oil container requires to be sealed to prevent the oil from spilling out of the container during the use of the chain saw.

In the standard design of chain saw, the oil reservoir contains a neck of circular cross section having a thread formed around the neck. A cap having a corresponding sized groove to receive the thread formed within the inner side wall of the cap is then screwed onto the neck of the container in order to seal the container. A rubber seal may be located within the cap which will be sandwiched between the inner base surface of the cap and the end of the neck of the fluid container to provide an oil tight seal.

However, in some designs of chain saw, particularly in the smaller and lighter designs intended for use by the general public rather than professional lumberjacks, the chain saw is designed to be compact and as such the space available for the oil container is severely restricted. Furthermore the space may be of an unusual shape located within an odd part of the body of the chain saw. The shape of the neck of the container may also be restricted by the shape of the passageway between an aperture within the external wall of the body of the chain saw where the opening of the neck of the container is able to be accessed by the operator and the container itself. This can result in the cross sectional shape of the neck of the oil container being non-circular and as such it is not possible to use a threaded cap in order to seal the neck of the container.

One proposed solution to such a non-circular neck is the use of a clip-on cap. The clip-on cap clips onto a lip formed around the entrance of the neck and which acts as a rim. However, it has been found that such a cap may leak particularly when the chain saw is inverted and the fluid is located against the cap. The problem is further exagerated by the vibration of the chain saw during use which rattles the cap allowing oil to seep between the joint between the cap and the neck of the fluid container.

The present design is intended to overcome or at least reduce the effects of the problems associated with the standard design of oil cap. Accordingly there is provided:

According to a first aspect of the present invention, there is provided a chain saw comprising an oil container for storage of lubricating oil, the container having a neck through which the container can be filled with a lubricating oil and a cap for sealing the neck of the container wherein the cap comprises a body having at least one elastically spreadable band located around the body along at least part of the length of the body and an actuating mechanism which is capable of moving the band from a relaxed inner position to a spread outer position into engagement of the inner surface of the neck of the container when the body of the cap is located within the neck of the container.

According to a second aspect of the present invention, there is provided a method of sealing a neck of an oil container on a chain saw with a cap comprising a body having at least one elastically spreadable band located around the body along at least part of the length of the body and an actuating mechanism which is capable of moving the band from a relaxed inner position to a spread outer position, the method comprising the steps of: i) inserting the body of the cap into the neck of the container whilst the band is in its relaxed inner position; ii) activating the actuating mechanism to move the band from a relaxed inner position to a spread outer position and into engagement with the inner surface of the neck of the container.

According to a third aspect of the present invention, there is provided a cap to seal the neck of an oil container of a chain saw comprising a body having at least one elastically spreadable band located around the body along at least part of the length of the body and an actuating mechanism which is capable of moving the band from a relaxed inner position to a spread outer position by inserting the body of the cap into the neck of the oil container whilst the band is in its relaxed inner position and activating the actuating mechanism to move the band to a spread outer position where it engages the inner surface of the neck.

The use of such a design of oil cap to seal the neck of the oil storage container on a chain saw in which the lubricating oil is stored has numerous advantages.

Firstly, the use of such a design of cap can enable the cap to be designed in a compact manner. It can be arranged that the whole or a substantial part of the cap can be located within the neck of the container thus saving space, enabling the chain saw to be made more compact. Further still, the use of such a cap can ensure that the minimal material is used in the construction of the container as neither a thread around the neck nor a lip around the entrance of the neck is required.

Secondly, the use of such a cap provides an oil tight seal between an inner surface of the neck and the cap. This provides the advantage that the mechanism which attaches the cap to the neck of the container also acts as the seal. This avoids the need for an additional washer or seal. By having the seal within the neck, it avoids having lubricating oil around the entrance of the neck as is the case of a clip-on cap or around the outside of the neck as is the case on the threaded cap. An additional washer or seal is required when a threaded cap is used in order to prevent the oil from leaking and is usually located at the entrance of the neck. However, lubricating oil is still able to flow to the entrance of the neck which can result in lubricating oil dripping from the neck when the cap is removed.

Thirdly, the resilient nature of the seal is ideal for use on a chain saw. During the operation of a chain saw, the body of the chain saw vibrates considerably. This results in the cap vibrating as well. However, as the band which forms the seal as well as attaching the cap to the neck is resilient, movement of the cap relative to the neck does not result in gaps forming in the seal between the cap and the inner surface of the neck thus preventing the seal from being penetrated by the oil, the band remaining in contact with the inner wall of the neck at all times. This is in contrast to a cap which clips onto a lip formed around the entrance of the neck. In such designs, the cap and the neck together with lip are formed from a relatively rigid material. As the chain saw vibrates, there is relative movement between the cap and the neck allowing a pathway to form between the cap and neck allowing the oil to penetrate thus causing it to leak.

Fourthly, the use of such a cap enables the neck of the container to be manufactured with a non-circular cross section. This type of cap is able to seal the neck of a container having a non-circular cross section whilst providing an oil tight seal.

Ideally, the shape of the cross section of the neck is oval. This shape enables the container to be filled more easily, particularly when compared to a neck having a circular cross section but with the same cross sectional area. However, it will be appreciated that the shape of the cross section of the neck could be other shapes such as square, rectangular, triangular, star shaped. The use of this type of cap can be adapted to seal the neck regardless of the cross sectional shape.

One method of constructing the cap is to have the shape of the cross section of the band when located in its relaxed inner position, and ideally, the body along its length, the same as the shape of the cross section of the neck. This provides one construction of cap which provides an oil tight seal for that neck of that cross sectional shape.

Fifthly, this type of cap can be used on oil containers having a neck wherein the longitudinal axis of the neck is non-linear and can be curved. Such a neck can be sealed using a cap having a body which is similarly curved, the rate of curvature being ideally the same.

Two embodiments of the invention will now be described in relation to the drawings, of which:

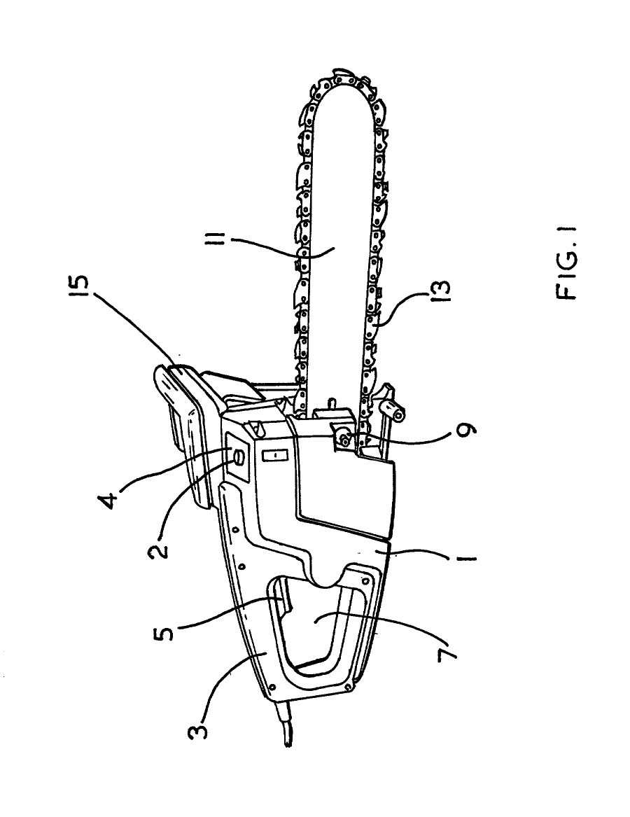

FIG. 1 shows a perspective view of a chain saw without an oil cap;

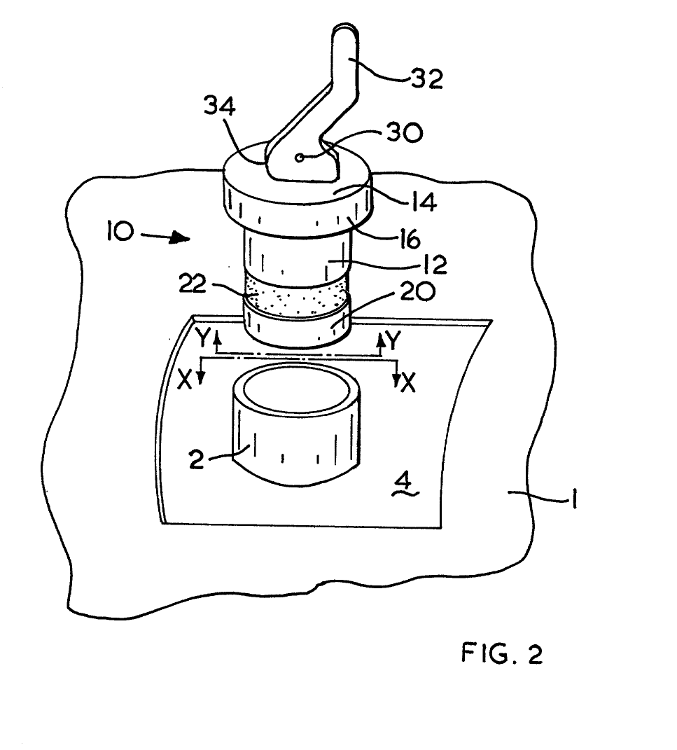

FIG. 2 shows a partial view of the part of the chainsaw where the neck of the oil container projects through the wall of the body of the chain saw together with the cap according to the first embodiment prior to insertion into the neck of the container;

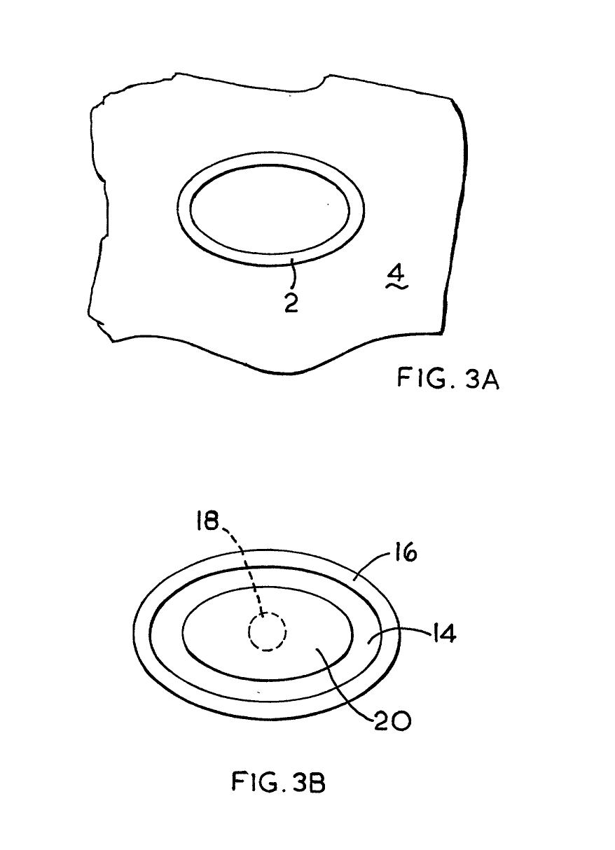

FIG. 3A shows a top view of the neck of the container in the direction of arrows X-X in FIG. 2;

FIG. 3B shows a bottom view of the cap in the direction of arrows Y-Y in FIG. 2;

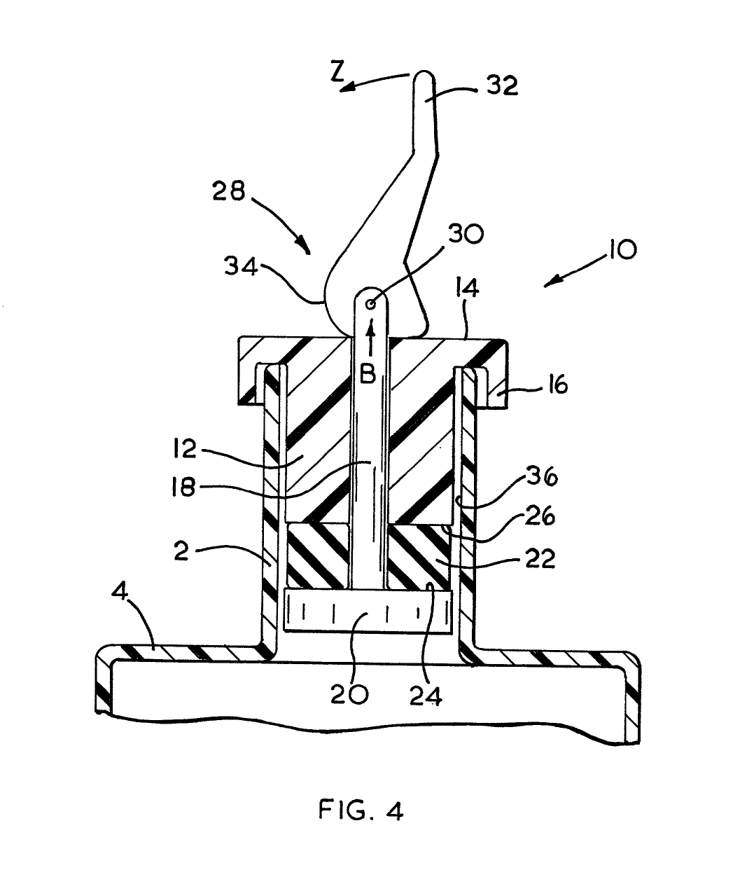

FIG. 4 shows a vertical cross section of the first embodiment of the cap located within the neck of the container in its open position;

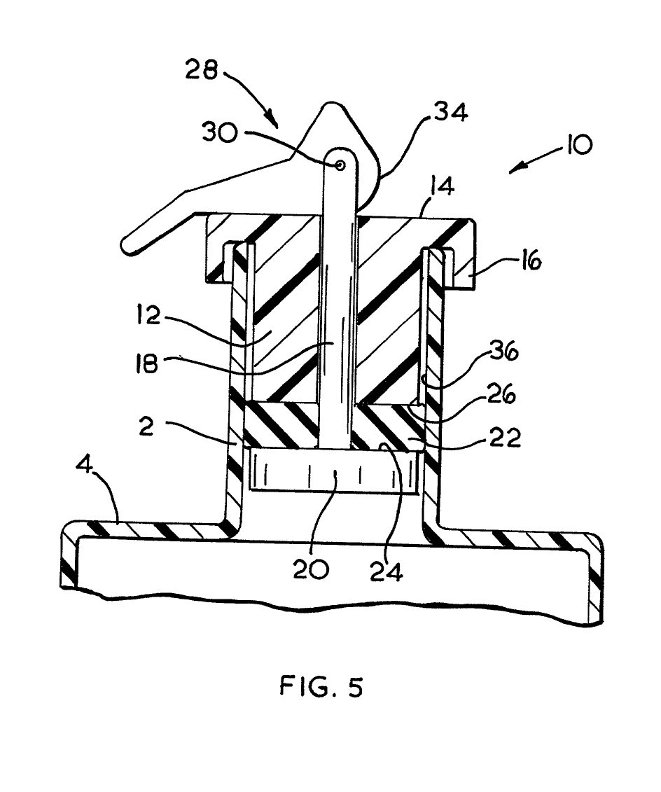

FIG. 5 shows a vertical cross section of the first embodiment of the cap located in the neck of a container in the locked position; and

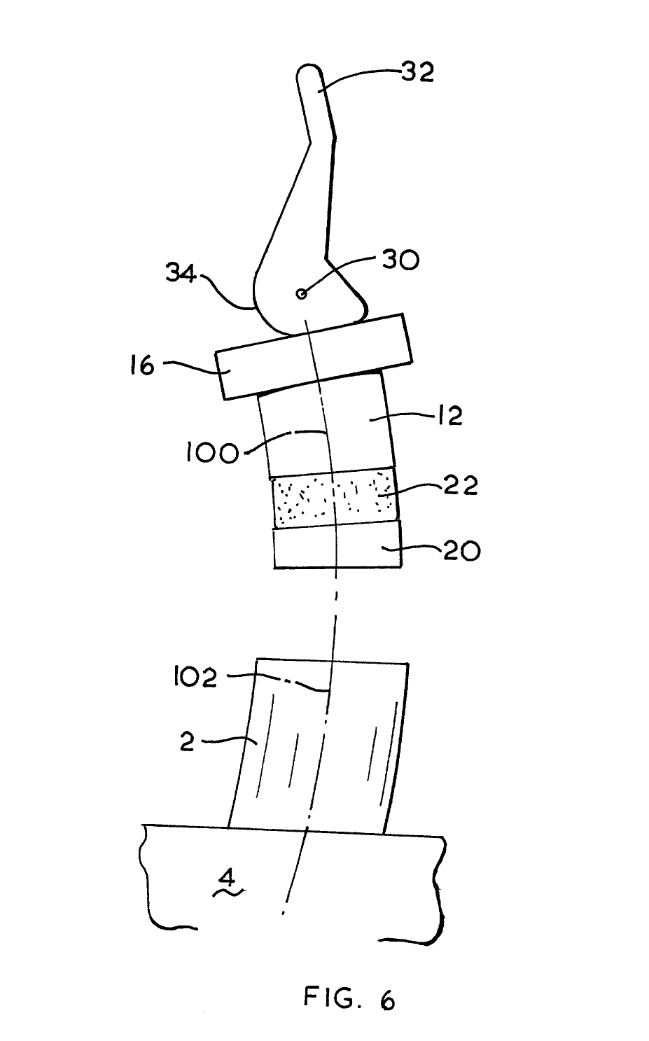

FIG. 6 shows a side view of the second embodiment of the cap prior to insertion into the neck of the container.

Referring to FIG. 1, the chain saw comprises a central body (1) having a rear handle (3) attached to the rear of the central body (1), a trigger switch (5) mounted in a central aperture (7) formed by the rear handle (3), a chain tensioner (9) which moves a chain bar (11) to tighten the cutting chain (13) which runs around the chain bar (11) in well known manner, an electric motor (not shown) which drives the chain saw and which is housed in the body (1), a front bale handle (not shown) attached to the side of a central body (1) and a handle guard (15).

In use the electric motor drives the chain (13) of the chain saw around the chain bar (11). In order to minimise friction between the chain (13) and the chain bar (11) as it rotates around the chain bar (11), lubricating oil is continually fed onto the chain (13) to lubricate the chain (13). A container (4) is mounted within the body (1) of the chain saw in which is stored the lubricating oil for use on the chain (13) of the chain saw. A pipe (not shown) feeds from the container (4) to a position immediately above the chain (13) so that the oil drips from the end of the pipe onto the chain (13) as it rotates around the chain bar (11). A valve (not shown) regulates the flow of oil onto the chain (13).

The container (4) is filled via a neck (2) which projects through an aperture formed in the wall of the body. The neck of the container (4) is oval in cross section as shown in FIG. 3A which is a top view of the neck (2) in the direction X-X in FIG. 2.

The tubular body (12) of the cap is similarly oval in cross section as shown in FIG. 3B which is a bottom view of the cap in the direction Y-Y in FIG. 2. The mechanism by which the stopper seals the neck (2) of the container (4) will now be described with reference to FIGS. 2, 4 and 5.

Referring to the drawings, FIG. 2 shows the neck (2) of the plastic bottle (4) which forms a container which acts as the oil reservoir on the design of chain saw. The cap comprises a plastic stopper shown generally (10) which comprises a tubular body (12) having a flange (14) formed at one end of the tubular body The flange (14) comprises a lip (16) formed around its periphery. The cap is of sufficient size to allow the lip (16) of the flange (14) to surround the neck (2) of the plastic bottle. Located within the tubular passage of the body (12) is a shaft (18). A plastic disc (20) which is coaxial with the shaft (18) and has a circular cross section is formed at one end of the shaft (18). The shape of the cross section of the disc (20) has substantially equal dimensions to that of the body (12). A rubber band (22) is sandwiched between the underside (24) of the plastic disc and the end (26) of the body (12). The rubber band (22) is oval and surrounds the shaft (18). At the other end of the shaft (18) is attached a camming mechanism (28). The end of the shaft is connected to the camming mechanism (28) via a pivot point (30). Attached to the camming mechanism (28) is a handle (32). The camming mechanism (28) is able to be pivoted between a first position as shown in FIG. 4 in the direction Z by the handle (32) to a second position shown in FIG. 5 and vice versa.

In order to seal the neck (2) of the oil reservoir, the operator inserts the sealing cap into the neck (2) of the bottle (4) with the handle (32) substantially co-axially aligned with that of the longitudinal axis of the shaft (18) as shown in FIG. 2. When the handle and camming mechanism are in this orientation (as shown in FIG. 2 and 4) the cap is able to easily be inserted into the neck (2) of the bottle (4). When the flange (14) abuts the end of the neck (2) the operator pivots the camming mechanism (28) by the use of the handle (32) from the position shown in FIG. 4 to that shown in FIG. 5. As the camming mechanism rotates, the cam (34) causes the pivot point (30) and hence the shaft (18) to move in direction B. The camming mechanism is pivoted all the way until it is in the position shown in FIG. 2. As the shaft (18) moves in the direction B, the disc (20) moves also in the same direction B and squeezes the rubber band (22) thus causing it to deform outwardly as shown in FIG. 5. As the rubber band (22) deforms outwardly, part of the rubber band (22) engages with the inner wall (36) of the neck (2) thus gripping the cap in relation to the inner wall of the neck (2) and provides a seal preventing oil retained within the bottle from escaping through the neck (2) of the bottle. The design of the cam (34) is such that it is bi-stable, namely that in the positions shown in FIGS. 4 and 5 it is held in place by the resilient force of the rubber band (22).

FIG. 6 shows the second embodiment of the present invention. Where the features of the first embodiment are the same as those in the second embodiment, the same reference numbers have been used.

The design of the second embodiment of the present invention is the same as that of the first embodiment. However, the longitudinal axis (100) of the body of the cap is curved. Similarly, the longitudinal axis (102) of the neck (2) is curved. The rate of curvature of the two longitudinal axes is the same.

The cap operates in the exact same manner as that described in the first embodiment.

1. A chain saw, comprising:
a container for storing lubricating oil;
a neck defining an opening in the container through which the container can be filled with lubricating oil;
a cap for sealing the neck of the container, the cap including a body;
a sealing member positioned on the body; and
an actuating mechanism capable of moving the sealing member from a first sealed position to a second unsealed position.

2. The chain saw of claim 1, wherein the shape of the cross section of the neck of the container is non-circular.

3. The chain saw of claim 2, wherein the shape of the cross section of the neck is oval.

4. The chain saw of claim 1, wherein the shape of the cross section of the sealing member when located in its first position is substantially the same as the shape of the cross section of the neck.

5. The chain saw of claim 4, wherein the shape of the cross section of the body along its length is substantially the same as the shape of the cross section of the neck.

6. The chain saw of claim 1, wherein a longitudinal axis defined on the neck is non linear.

7. The chain saw of claim 1, wherein a longitudinal axis defined on the neck is curved.

8. The chain saw of claim 6, wherein a longitudinal axis defined on the body is non linear.

9. The chain saw of claim 8, wherein the longitudinal axis of the body is curved.

10. The chain saw of claim 1, wherein a longitudinal axis defined on the body of the cap and a longitudinal axis defined on the neck of container are co-aligned when the body of the cap is located within the neck of the container.

11. The chain saw of claim 1, wherein the sealing member comprises an elastically spreadable band located around the body.

12. The chain saw of claim 1, wherein the first position is a relaxed inner position.

13. The chain saw of claim 1, wherein the second position comprises an outer position and the sealing member engages the inner surface of the neck of the container.

14. The chain saw of claim 1, wherein the sealing member is resilient.

15. A method of sealing an oil container on a chain saw comprising the steps of:
providing a neck defining an opening in the container;
providing a cap including a body;
providing a sealing member located on the body;
providing an actuating mechanism;
inserting the body of the cap into the neck of the container; and
moving the actuating mechanism from a first position to a second position to cause the sealing member to seal the container.

16. The method of claim 15, wherein the shape of the cross section of the neck of the container is non-circular.

17. The method of claim 16, wherein the shape of the cross section of the neck is oval.

18. The method of claim 15, wherein the shape of the cross section of the sealing member in its first position is substantially the same as the shape of the cross section of the neck.

19. The method of claim 18, wherein the shape of the cross section of the body along its length is substantially the same as the shape of the cross section of the neck.

20. The method of claim 15, wherein a longitudinal axis of the neck is non linear.

21. The method of claim 20, wherein the longitudinal axis of the neck is curved.

22. The method of claim 15, wherein a longitudinal axis defined on the elongate body is non linear.

23. The method of claim 22, wherein the longitudinal axis of the elongate body is curved.

24. The method of claim 15, wherein a longitudinal axis defined on the body, a longitdunial axis defined on the cap and a longitudinal axis defined on the neck of container are co-aligned when the body of the cap is located within the neck of the container.

25. The method of claim 15, wherein the sealing member comprises a spreadable band positioned on the body.

26. The method of claim 15, wherein the second position comprises a outer position and in this outer position the sealing member engages an inner surface of the neck of the container.

27. A method of unsealing an oil container on a chain saw comprising the steps of:
providing a neck defining an opening in the container;
providing a cap including a body;
providing a sealing member located on the body;
providing an actuating mechanism;
removing the body of the cap from the neck of the container; and
moving the actuating mechanism from a second position to a first position to cause the sealing member to unseal the container.

28. A chain saw, comprising:
an oil container for storage of lubricating oil;
a neck through which the container can be filled with lubricating oil;
a cap for sealing the neck of the container, the cap comprising a body having an elastically spreadable band located around the body along at least part of the length of the body and an actuating mechanism capable of moving the band from a relaxed inner position to a spread outer position into engagement with the inner surface of the neck of the container when the body of the cap is located within the neck of the container.

29. A chain saw, comprising:
a body;
a handle positioned on the body;
a chain bar extending from the body;
a cutting chain disposed around the chain bar;
an oil container located on the housing for storing lubricating oil;
a neck including an inner surface, the neck defining an opening in the container through which oil can enter the container;
a cap for sealing the neck of the container comprising a body and an elastically spreadable band located around the body; and
an actuating mechanism attached to the cap, the actuating mechanism capable of moving the elastically spreadable band from a first unsealed position where the elastically spreadable band does not contact the inner surface to a second sealed position where the elastically spreadable band does contact the inner surface to prevent oil from entering or leaving the container.

30. The chain saw of claim 29, further comprising a chain tensioner to move the chain bar to tighten the cutting chain.

31. The chain saw of claim 30, further comprising a handle guard.
